(19) United States
(12) Patent Application Publication
(10) Pub. No.: US 2013/0035909 A1
(43) Pub. Date: Feb. 7, 2013

(54) SIMULATION OF REAL WORLD EVOLUTIVE AGGREGATE, IN PARTICULAR FOR RISK MANAGEMENT

(71) Applicants: Raphael Douady, Paris (FR); Ingmar Adlerberg, Paris (FR); Olivier Le Marois, Paris (FR); Bertrand Cabrit, Paris (FR)

(72) Inventors: Raphael Douady, Paris (FR); Ingmar Adlerberg, Paris (FR); Olivier Le Marois, Paris (FR); Bertrand Cabrit, Paris (FR)

(21) Appl. No.: 13/384,093

(22) PCT Filed: Jul. 13, 2010
(86) PCT No.: PCT/FR2010/000506

§ 371 Date: Jun. 26, 2012

(30) Foreign Application Priority Data
Jul. 15, 2009 (FR) 0903456

(51) Int. Cl. G06F 7/60

(52) U.S. Cl. 703/2

(57) ABSTRACT

The invention concerns a computerized system for simulating real-world evolving aggregates including a memory, for storing data structures, proper, for a given real-world element, with an element-identifier and a series of element-magnitudes corresponding to the respective element-dates. The memory then stores the aggregate data, defined by groups of element-identifiers, each group being associated with a group-date, whereas an aggregate-magnitude can be derived from element-magnitudes corresponding to the group's element-identifiers, at each group-date. The system also includes a simulation generator, arranged to establish a computer model relative to an aggregate to match particular functions to respective leading parameters, selected for the aggregate in question, each particular function resulting from adjustment of the history of the aggregate magnitude with respect to the history of its respective leading parameter, up to a residue, the adjustment being attributed a quality score. In addition, the model relative to the aggregate includes a collection of mono-factorial models, defined by a list of leading parameters, a list of corresponding particular functions and their respective quality scores.

The present invention concerns the computerized simulation of real-world phenomena.

As a rule, we know how to make an “intrinsic” computer simulation of a given real-world object, a machine for example, taken in isolation. Such a machine could be considered as a homogeneous real-world element. On the other hand, intrinsic simulation does not take machine/real-world interactions into account. A tornado, for example, could make the machine inoperable.

Building an “extrinsic” simulation of the machine, one taking the possibility of a tornado into account, is much harder. This belongs to risk management. Risk management has a wide variety of applications, including:
Architecture, calculating the resistance of structures subjected to internal or external stress, whether buildings, ships, vehicles, factories, etc. The stress can be external: geological, meteorological, etc., or internal: industrial activity, engines, immediate environment, etc.
Trajectory calculation (aerospace or other navigation systems) integrating meteorological forecasts, risk of breakdown or accident (probability of accidents related to a model of the environment for example), and other random delaying-factors
Simulations of profit or loss resulting from operations on financial markets intended to control the costs of industrial activity (for example loan repayments, fuel or electricity costs, etc.)
Simulations of industrial production integrating factors such as estimated delivery times for raw materials, the probability of employees being active (as opposed to those on sick-leave or on strike, for example), the probability of continuous production (machines running smoothly versus scheduled down-time for servicing or breakdown),
Simulation of computer networks and the volume of data to be processed by a system node over a given period,
Simulation of electrical power grids and possible node overload at a given moment, or
Bioinformatic simulation of the relations and interactions among various parts of a biological system (for example a network of proteins/enzymes or the biochemical reactions of a given metabolic pathway) taking the various parameters into account (for example an enzyme's capacity for regio- and/or stereospecific catalysis) in order to establish an operating model for the system as a whole.

The above examples show that risk management has a very wide variety of application.

In general, risk management results in a risk-measure quantity. One of these is “value at risk” (VaR), to which we shall return in the detailed description below.

The present invention could apply to physical aggregates, each of which includes a mass, i.e. voluminous, set of real-world heterogeneous elements. Here, the term “heterogeneous element” is used as distinct from a homogeneous element represented by a given machine taken in isolation.

One known approach to the simulation includes a historical analysis of the aggregate in question, ignoring its environment, in such a way as to deduce the possible bounds to its variations.

Another, more advanced approach takes the environment into account. Here, the simulation includes the adjustment of a selected type of “model function” for it to match the aggregate's history as a function of its environment as closely as possible. Variations of the environment are then simulated, and then, using the model function, variations of the aggregate are deduced. The model function can include a random factor, which brings us to a complement described below.

Being a mass aggregate whose composition changes over time, referring to the various component elements of the aggregate cannot be done. The so-called “model function” will thus use a limited number of arguments, chosen in a way we shall describe below.

### DEFINITION OF THE INVENTION

For reasons we shall return to later, none of these approaches is fully satisfactory. All have various downsides including that of poorly accounting for exceptional situations such as the above-mentioned tornado.

The invention is designed to improve the situation by using an approach both more exhaustive, and distinctly different from that which is known from the current state of the technical art today.

The invention therefore introduces a computer system simulating an evolving real-world aggregate, including:
memory, to store
   basic data relative to the history of real-world elements, these basic data include the data structures (Data1; Data2), proper, for a given real-world element, to establishing an element-identifier, as well as a series of element-magnitudes corresponding to the respective element-dates, as well as
   aggregate data, where each aggregate (A) is defined by groups of element-identifiers (Data3), each group being associated with a group-date, whereas an aggregate magnitude can be derived from element-magnitudes corresponding to the group's element-identifiers, at each group-date, and
a simulation generator, arranged to establish a computer model relative to an aggregate.

According to one aspect of the invention, for a given aggregate (A), the simulation generator is arranged to match particular functions (Fⱼ) to respective leading parameters (Yⱼ), selected for the aggregate in question (A), each particular function resulting from adjustment of the history of the aggregate magnitude with respect to the history of its respective leading parameter, up to a residue (Resⱼ), the adjustment being attributed a quality score (PVⱼ).

Then, the model relative to aggregate (A) includes a collection of mono-factorial models, defined by a list of leading parameters (Yⱼ), a list of corresponding particular functions (Fⱼ) and their respective quality scores (PVⱼ). The residues (Resⱼ) are optional.

According to another aspect of the invention, the simulation generator includes:
a selector, capable, upon designation of an aggregate (A), of parsing a set (SE) of real-world elements defined in the basic data, and selecting from it leading parameters (Yⱼ) according to a selection condition, one which includes the fact that a criterion of guideline-parameter influence on the aggregate (A) represents an influence exceeding a minimum threshold, and
a calibrator, arranged to make the respective particular functions (Fⱼ) correspond to each of the selected leading parameters (Yⱼ), each particular function resulting from adjustment of the history of the aggregate magnitude compared to the history of the relevant leading parameter, up to a residue (Resⱼ), the adjustment being attributed a quality score (PVⱼ) .

Other characteristics and advantages of the invention will appear upon examination of the detailed description below, and of the drawings in the annex, where:

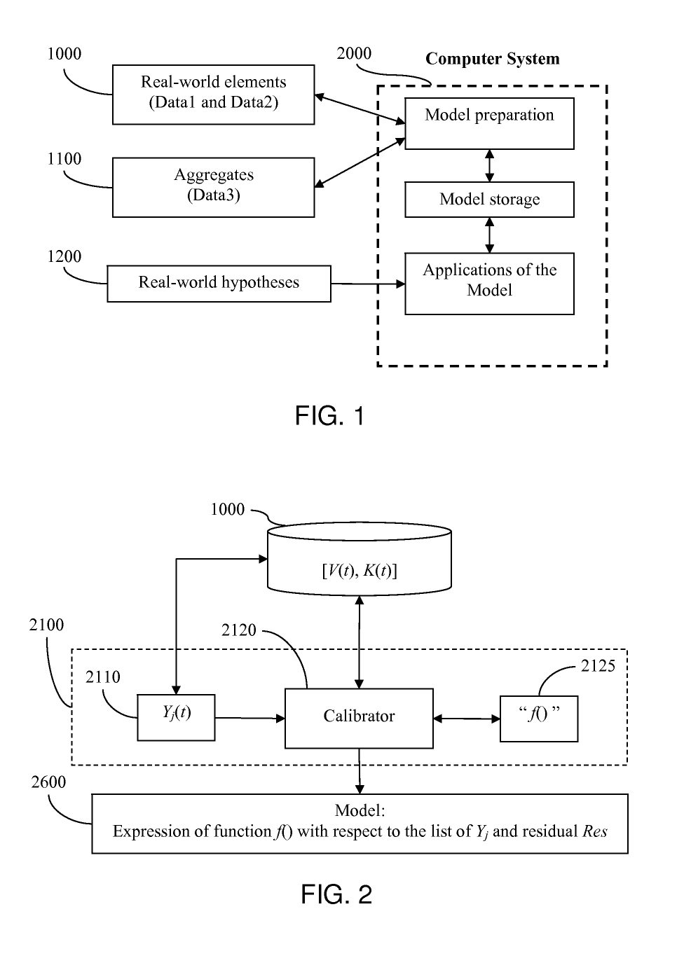

FIG. 1 illustrates the overall structure of a simulation device,

FIG. 2 illustrates the diagram of a known simulation device,

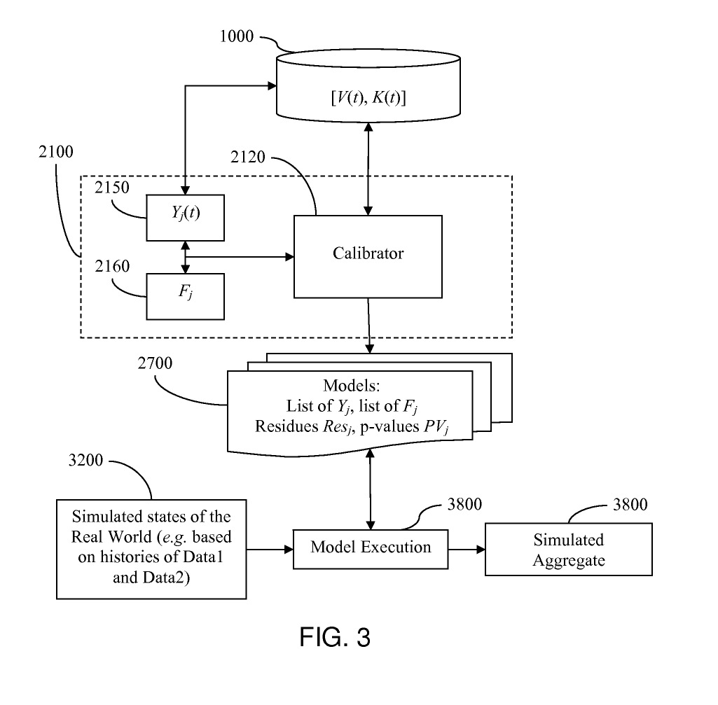

FIG. 3 illustrates the diagram of a simulation device such as the one proposed here,

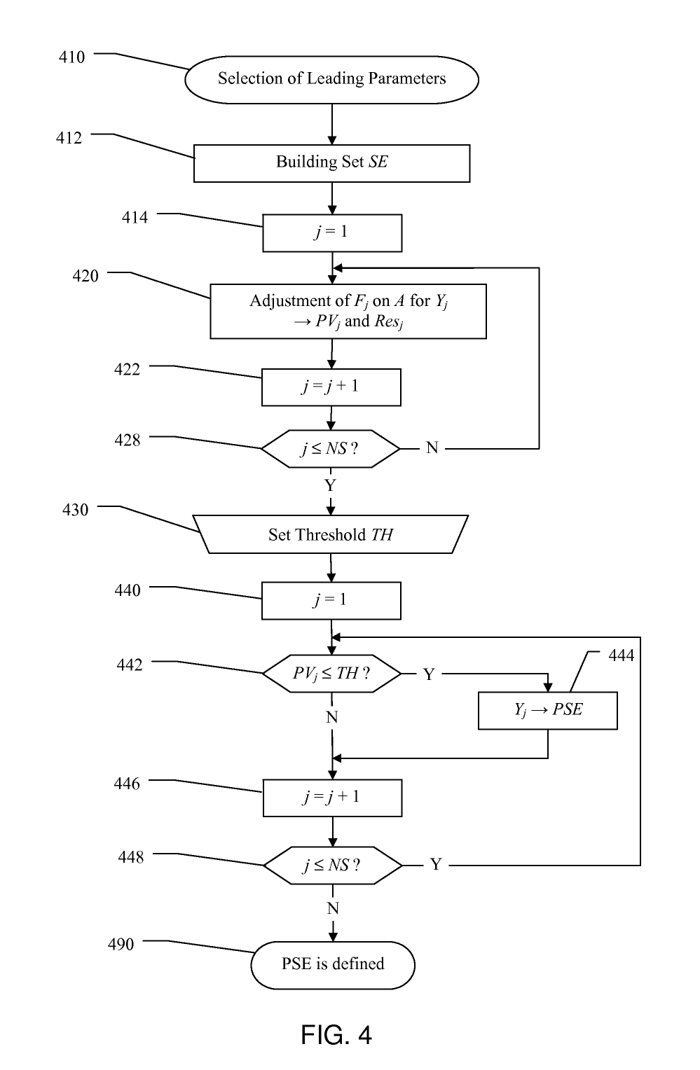

FIG. 4 is a flow diagram of the invention's guideline-parameter selection-mechanism,

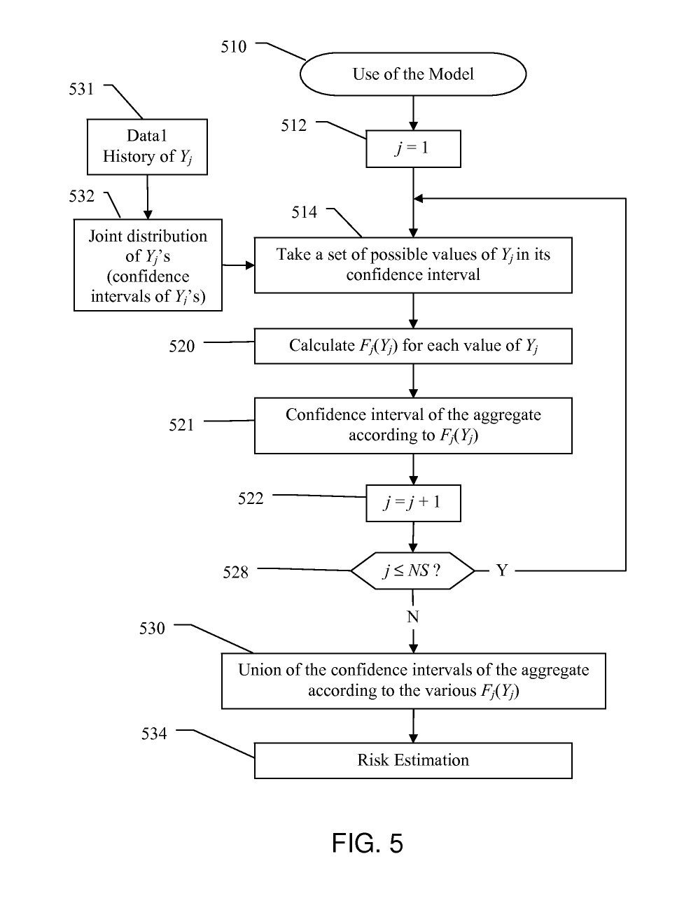

FIG. 5 shows usage of the invention for estimating a resulting level of risk from a collection of individual models, without using special modeling of the interactions between the various models,

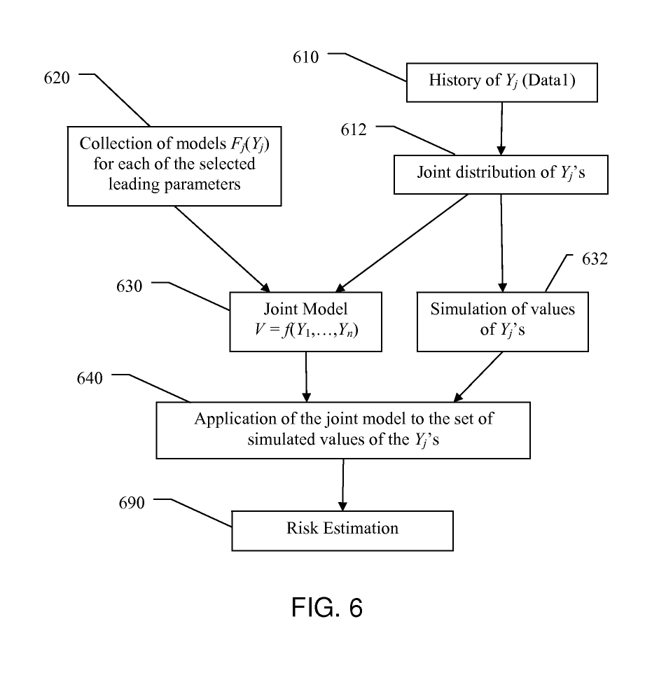

FIG. 6 shows another usage of the invention for estimating a resulting level of risk from a collection of individual models, using a model of the correlations between the various models' leading parameters,

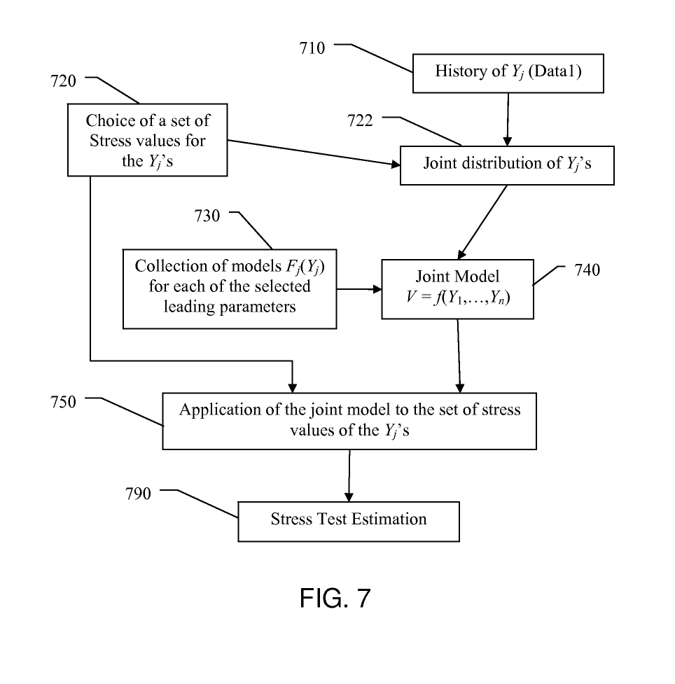

FIG. 7 shows a usage of the invention for estimating a resulting level of stress from a collection of individual models, under a hypothetical environmental scenario, and

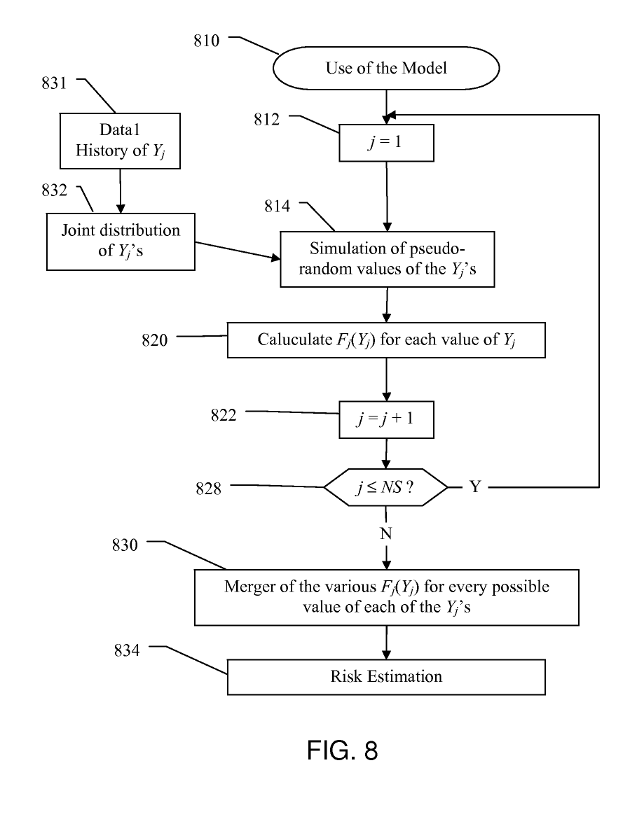

FIG. 8 shows a usage of the invention for estimating a resulting level of risk from a collection of individual models, using a pseudo-random simulation, also known as “Monte Carlo” simulation, of the leading parameters.

The following drawings and description essentially contain elements the nature of which is certain. The drawings are part and parcel of the description and may therefore not only make the present invention easier to understand, but also, if need be, contribute to its definition.

Moreover, the detailed description is bolstered by Annex A which contains the various expressions, relations and/or formulas used in the detailed description below. The Annex is separate from the description for reasons of clarification on the one hand, and to facilitate references on the other. Like the drawings, the Annex is part and parcel of the description and may therefore not only make the present invention easier to understand, but also, if need be, contribute to its definition.

The numbers of the relations are in brackets in the Annex, but square brackets in the description (for greater clarity). Likewise, in certain parts of the document, indices are indicated by preceding them by an underscore; T_i thus corresponds to Tᵢ.

Description of a General Simulation Device

FIG. 1 Illustrates the Overall Structure of a Simulation Device

To start, a large collection of real-world data is required, stored here in a real-world memory 1000. For reasons of clarity, the method described refers to a memory 1000 consisting of various memory zones each containing distinct data. Obviously, the memory 1000 can store the distinct data in a single zone of physical memory. On the other hand, each memory zone could be included in a physical memory of its own (for example, for four memory zones, there would be four distinct physical memories).

The data can be highly variable and include real-world elements, parameters with a direct or indirect influence upon these elements, subsets of elements (aggregates) or even sets of subsets (several aggregates) to which we shall return later.

Here, the word “element” refers to any element of the real-world data universe, including the parameters. In fact, as soon as a magnitude, even calculated—a correlation for example—, is considered a source of risk, it must be labeled, and be given a history. It hence becomes an “element”.

Basically, the memory 1000 contains first the data structures (Data1, or “first data”) on the real-world elements or objects. A first data structure (Data1) can be described as a multiplet, which includes an element-identifier (id), an element-value (V) and an element-date (t), as illustrated by Expression [1] in the annex. The Data1 data structures are to be understood as follows: the multiplet represents the element-value, at the element-date indicated, of a real-world element designated by the element-identifier. The element-date can be a date and a time (according to precision required), or a time only, or a date only, according to the rate of evolution chosen for the set of elements considered.

These multiplets are organized in one or more tables of one or more databases. Other equivalent computer representations are also possible.

Each element evolves over time. The evolution can be tracked and recorded by means of the multiplets and more precisely by associating element-values with the element-dates included in the multiplets. The distinction between the evolution of an element with respect to another is facilitated by the element-identifiers proper to each distinct element (there is a unique element-identifier for a given element).

The memory 1000 also contains Data2 data structures (“second data”). A second data, Data2, represents the evolution of an element over time. According to Formula [2], the second data, Data2, is a collection of Data1 values, from a start time t₀ to an end time t_{F}, with a chosen temporal periodicity (sampling rate). Since the identifier id is common to all the Data1 multiplets of Formula [2], it can be removed and associated with Data2 directly. We thus obtain Formula [3]. This is written more symbolically as per Formula [4], in which the index i corresponds to the identifier id of element Eᵢ and the index k corresponds to the temporal sampling tₖ. Its list of values Vᵢ(tₖ) can be seen as a computer table Vᵢ of the “array” type (or vector, in the computing sense of the term). In short, vector Vᵢ merely represents the evolution of element Eᵢ over time.

The memory 1000 also contains Data3 data structures (“third data”). A third data, Data3, represents an aggregate of real-world elements. Formula [5] indicates the composition at instant t₀ of the aggregate Aₚ (the index p is an aggregate-identifier). This aggregate contains elements Eᵢ, in respective quantities qᵢ. The number of elements Eᵢ at instant t₀ is noted CardAₚ (t₀. A third data, Data3, can include three vectors of size CardAₚ(t₀, as illustrated by Formula [5]:
a vector of identifiers idᵢ, containing the respective id of the various elements Eᵢ,
a vector Q containing the quantities qᵢ, and
a vector V containing the corresponding values Vᵢ. It is the element-value Vᵢ of the element Eᵢ having the identifier idᵢ in question. As a variant, one can record the product of quantity qᵢ by element-value Vᵢ, to avoid having to do this product later. It is possible to record on the one hand the total value of the aggregate VT (Aₚ) as illustrated by Formula [6], and on the other the “weight” Wᵢ of each of the elements Eᵢ in the aggregate, in other words the ratios Wᵢ=qᵢVᵢ/VT(Aₚ), as illustrated by Formula [7].

These vectors form a three-dimensional table (a multidimensional “array”), which we call here aggregate-matrix.

A third data, Data3, can therefore be described in the aggregate-identifier/aggregate-matrix/aggregate-date format, where the aggregate-identifier designates an aggregate, whereas the aggregate-matrix designates the composition in elements and/or value in elements of the aggregate at the indicated aggregate-date, here t₀ (in other words which elements are part of a given aggregate at a given date, in which quantities, and with which value, either individual or global). Note that the composition of the aggregate can evolve as a function of time. Consequently, the number CardAₚ(tₖ) of elements Eᵢ at instant tₖ can be different from CardAₚ(t₀).

In the aggregate-matrix, the element-identifiers can be implicit, for example if the matrix has as many lines as elements being considered. In this case, the line of row i is always attributed to the same element Eᵢ. The aggregate-matrix can thus be reduced to vector Q of the quantities qᵢ and vector V of the values. This is what Formula [8] shows for the state of the aggregate Aₚ at instant t.

A special case is when the aggregate Aₚ is reduced to a single element Eᵢ. In this case, the aggregate-matrix has only a single line and the aggregate can be identified with this element Eᵢ. This does not prevent two distinct data structures Data2 and Data3 from coexisting, since Data3 can also contain aggregates that are actually multiple and others reduced to just one element.

As to aggregate Aₚ above, it concerns only a single time, namely t₀. Over the time interval running from t₀ to t_{F}, the state of the aggregate will be represented by a plurality of lines similar to Formulas [5] and/or [8]. Thus, in the notations Vᵢ(t) and Kᵢ(t) of Formula [8] , the ending (t) is a reminder that they are variables which depend on time or, more exactly, a series of samples over time.

This corresponds to a plurality of matrices, as summarized symbolically in Formula [9]. It is what we shall henceforward call “matricial history” for aggregate Aₚ in question.

Generally, the third data (Data3) are subsets of chosen elements forming groups of multiplets. Each group is designated by an aggregate-identifier. The set of groups, as a function of time, is organized in one or more tables of one or more databases. Obviously, other equivalent computer representations are possible. An aggregate is at least a file of dates and values.

Optionally, “aggregates of aggregates” can be defined. In this case, the memory 1000 can include a set of “fourth data”, Data4, in the form of a computer representation of a data structure reflecting a group of matrix pluralities, where each plurality of matrices corresponds to an aggregate's evolution as a function of time. These fourth data can be determined directly from the first, second and third data, as illustrated by Formulas [10] and [11], in which letter B represents an “aggregate of aggregates” and wₚ(t) the weight of the aggregate Aₚ in B at date (t). They can be useful particularly as intermediate data, facilitating establishing the computer model using the calibration utility, as we shall see, or, more simply, as representation of a composite system which naturally decomposes into sub-systems themselves composite.

Referring to FIG. 1, in a computer system 2000, the real-world data are first used to prepare a physical model (specific to computer implementation). This is done in a calibration utility 2100, following which a computerized representation of the model is stored in a memory 2600. For this the calibration utility 2100 accesses the data stored in the memory 1000. The simulation data are those of fictitious past states and/or predictions of future real-world states.

The simulation device can be used in architecture for the dimensioning of constructions, be they buildings, vehicles, or ships. It can also be used for piloting a meshed electrical power grid, telephone networks, or even an internet network. It can also be used for quality control of a chemicals, pharmaceutical or food production line. It may also be used for studying hydrographic or meteorological risks. Other applications include the logistic management of transport networks, such as taxicab fleets, or even modeling the propagation of epidemic or pollution risks. Naturally, the simulation device can be used for analyzing financial risks.

Prior Art

Making a simulation device according to prior art is illustrated in FIG. 2.

FIG. 2 shows how the calibration 2100 is done, to reach a function of adjustment in 2120:
a. observed and/or measured aggregate data are available: V(t) and Q(t), these data being stored in the real-world memory 1000;
b. a selector 2110 chooses a set of explanatory factors of model Yⱼ, which here we call “leading parameters”; and memorizes their designations in the memory 1000;
c. a calibrator 2120 performs a best-fit adjustment, making it possible to determine the precise expression of a function f(Y) where Y=(Y₁, . . . Yⱼ, . . . , Yᵣ) is the vector representing the set of leading parameters, and a residue Res. The adjustment consists for example in determining the coefficients of the function f( ). The residue Res represents the deviation between the model f(Y) and the observed value V.

In fact, it depends on time, and requires using V(t), de Y(t), and Res(t).

A new source of complexity then crops up with the possible “delay effects”, in other words the correct modeling of value V(t) requires including the values of leading parameters Yⱼ at earlier dates t′. Typically, the expression of the model used for V(tₖ) will involve the Yⱼ(tₕ) for date indices h<k.

Hence, according to a known modeling approach, it is considered (at operation b) that the evolution of elements is directly or indirectly related to certain parameters that could be qualified as “leading parameters” of the state of the system, or even “explanatory factors of the model”. Physically, these parameters can be considered as “state variables” in the real-world “phase space”. For further details, see the links and references below:
http://en.wikipedia.org/wiki/Phase space
http://en.wikipedia.org/wiki/State space (controls)
J. Lifermann “Systèmes linéaires. Variables d′état.” 1972

At stage c, the precise or particular expression of the function f(Y) can be determined by starting from a generic (parameterized) expression of the function f(Y). This generic expression can be stored in the calibrator 2120 or, separately, in the 2125. For example, if the function f(Y) is a linear combination, its generic expression is given by Relation [12] in the annex, where the yⱼ are variables, and the aⱼ coefficients to be determined. The integer j is the indexation of selected leading parameters.

In other words, the calibrator (2120) operates to establish the particular functions as from a set of expressions of generic functions of unknown coefficients (2160). This set of expressions of generic functions of unknown coefficients (2160) can include expressions of non-linear generic functions.

After best fit (adjustment), the precise particular expression of the function f(Y), with the values of aⱼ is stored in 2600. The model is thus expressed according to the Relation [13] in the annex, where the Yⱼ are the leading parameters, and Res designates a residue, which contains a history, and reflects the imperfection of function f in representing the aggregate precisely.

Thus the modeling includes:
the choice of the leading parameters: Y₁, Y₂, . . . Yⱼ, . . . Yₙ;
the choice of the mathematical form of the function f(Y) appropriate to the state of the aggregate, including the number of authorized delays,
the search for coefficients of the function f(Y) and
determining the historical residue Res(t), as well as one or more related magnitudes, as a risk associated with the residue.

The model resulting from the calibration is stored in 2600, and includes:
the list of identifiers Yⱼ of the leading parameters,
a computerized representation of the precise expression of the function f, generally a list de coefficients, particularly when the function f( ) is linear,
possibly, the historical residue Res(t),
possibly, magnitudes related to the quality of the calibration.

We shall now explain a phenomenon which occurs when the technique is applied to a large aggregate A, with a high number of indices.

The difficulty is that the number of coefficients of the model f(Y) (that which is sought) could be greater than the total number of historical data, the V(t) (that which is available). In this case, the problem is of the so-called “under-specified” type, in other words the calibrator can produce highly different solutions in a random manner, making it rather unreliable, and hence non-utilizable. In addition, even when the problem is not per se “under-specified”, in other words when enough historical data is available, the calibration can become numerically unstable and imprecise due to “colinearities” between the historical series of leading parameters.

The same phenomenon occurs when the mathematical expression of the function f( ) is for example a high-order polynomial, more generally a mathematical form of such complexity—because of non-linearities and delay effects—that the number of coefficients to be determined is greater than the total number of historical data available, or even when colinearities exist between the historical series of “elementary bricks” of the model's mathematical form.

In practice, one starts with a limited set of n factors or leading parameters Yⱼ, of constant composition over time. Searching for the function f(Y) appropriate to the state of the aggregate A can be done by known techniques of linear or non-linear adjustment. The set of n leading parameters Yᵢ is itself an aggregate of constant composition. To distinguish it, we shall henceforward call it pseudo-aggregate.

The leading parameters come from the real world. The function is generally a simple linear combination. In other words, one constitutes a pseudo-aggregate of leading parameters, of constant composition over time, which is supposed to represent the evolution of the aggregate in question.

What remains to be dealt with is the fact that the problem is “under-specified”, in other words to reduce the number n of the aggregate's leading parameters.

It can be done automatically using a technique called “model selection”: starting from a large number of possible leading parameters, models are calibrated by involving only subsets of leading parameters (in limited number), and selecting the model, in other words the subset of parameters, optimizing a certain criterion (by stepwise regression for example). More detailed information is available through the following links:
http://en.wikipedia.org/wiki/Stepwise regression
http://en.wikipedia.org/wiki/Model selection

Other information on known calibration techniques may also be found in the following works:
Ch. Gouriéroux, A. Monfort “Séries temporelles et modèles dynamiques” Economica, 1995
J. D. Hamilton “Time Series Analysis” Princeton University Press 1994

In real life, these purely automatic procedures are not always totally satisfactory. They tend to provide a model which works well in routine situations, but diverges as soon as it encounters an exceptional situation, such as extreme conditions. The resulting temptation is to re-calibrate the model, which often changes it completely and makes the calibration unstable.

For these reasons, knowledgeable persons will tend towards an intuitive approach, by forcing the pseudo-aggregate to contain leading parameters chosen by themselves. They choose these “forced” leading parameters based on their perception and understanding of the underlying phenomena and, naturally, their experience. In addition, and always based on their knowledge of the problem, they will choose, a priori, the mathematical form of the function f, by trying to keep the complexity under control, often to the detriment of the model's relevance, for example by rejecting the non-linearities and delay effects, even if they are corroborated by experience. In short, the technique is largely dependent upon the qualifications of the specialists in question, and loses its automation.

The leading parameters are generally chosen from real-world elements which could influence the real-world behavior of aggregate A when subjected to movements of great amplitude. The goal is to find those with the greatest influence under these conditions.

This sort of modeling is for example used to determine how the aggregate behaves under such and such a condition, by varying the values of the leading parameters Yⱼ. This is called a “stress test”, the quality of which can be highly compromised if a leading parameter has been ignored. The present invention will notably improve the precision and reliability of “stress tests”.

Next, all or some of the three main stages could be implemented: selecting the relevant leading parameters; estimating hypotheses of the leading parameters' possible evolutions; and estimating the aggregate's evolution according to these various hypotheses.

The situation in which the environment is unknown is equivalent to supposing that the only leading parameter is the past evolution of the aggregate itself.

Such a simulation device can simulate the behavior of various types of real-world aggregate, based on a past history. This sort of simulation applies to complex systems, subjected to potentially highly numerous and very different sources of risks. In such situations, extreme disturbances can be observed, if not chaotic and/or unpredictable behavior.

Real-world phenomena are of both highly varied type and behavior. They evolve according to laws of evolution which may be deterministic and/or random. Roughly speaking, the laws of evolution are proper to each aggregate and dependent upon the heterogeneous elements composing it.

It follows that simulations in view of predicting the behaviors of real-world phenomena require a plurality of parameters generally hard to pin down. Logically, the parameters must be directly or indirectly related to the heterogeneous elements composing the aggregates.

In weather forecasting for example, the aggregate includes among others a parameter related to air movement (itself dependent upon various elements such as air pressure, temperature and density, as well as relative humidity), a parameter related to the atmosphere (generally this is a system with variable changes at each point), a parameter related to the position of weather stations, a parameter related to the behavior of air on a wide scale and, lastly, a parameter related to the behavior of air on a small scale.

Concerning a portfolio of financial instruments, defining and choosing which parameters are related to the heterogeneous elements of a given aggregate is not trivial. Classically, the distribution of returns of a particular portfolio is taken into account. This distribution is often supposed to follow one of the known classes of probability distributions, for example the so-called normal or Gaussian distribution, with a view of generalizing the portfolio's returns by a mathematical function.

Another approach in financial portfolio management is the use of historical distributions or samples. With this approach, past distributions are taken into account where the aim of which is to foresee a behavior a given portfolio could exhibit in a future situation, presumed similar to a past situation.

However, this approach has its disadvantages. For example, it is dependent upon the size of the historical sample in question: if too small, the simulations are not very precise, and if too big, problems of time consistency (comparison of non-comparable results, change of portfolio composition or investment strategy) are encountered.

In finance, the leading parameters Y₁, Y₂, . . . Yⱼ, . . . Yₙ, may, in the main, be the values of securities on the market, indices or rates. They are sensitive to a vast range of real-world factors, all the way up to natural catastrophes and war. Managing their impact could prove vital for an investment fund set up to guarantee insurance payments or pensions to individuals, the amounts of which are themselves subject to the ups and downs of market and/or socio-economic parameters such as inflation or demographics.

In the food industry, such as the manufacture of dairy products, the leading parameters can be the milk's various nutrient and/or micro-organism levels, which need to be taken in to account in order to control the finished product's composition.

In architecture, the leading parameters could be wind and/or current speeds, tremor amplitudes, etc. Likewise, the values of constraints imposed upon the structures must be anticipated in order to dimension accordingly.

In medicine and pharmacology, the amplitude of a biological element's reaction to certain quantities of product subjected to it will be quantifiably determined in vitro. Following this, the same test will be conducted on animals in vivo, then on human beings. In this case, extreme reactions must imperatively be anticipated and product-product interactions taken into account. The influence of parameters other than the quantities of product injected is important too: temperature, patient's blood test, etc.

Simulation includes devising a model that reflects a global representation of the chosen aggregate's evolution under given circumstances (phenomenon). Even if the model in question can be qualified as a “mathematical model”, it must still be borne in mind that it's actually a real-world model, i.e. a physical model, using mathematical expressions. The difference is important: a mathematical formula as such remains valid no matter what the input magnitudes applied; on the other hand, a physical model is only valid if it corresponds to what happens in the real world; it is pointless for other applications, which represent most cases.

Mathematical formulas apply to book-keeping, for example: the arithmetical operations involved are valid no matter what the figures used. This is true for other economic methods, the mechanism of which works no matter what the values involved.

The same does not apply for non-accounting techniques, such as risk forecasting, simulation or estimation. These techniques are valid for a limited scope of application; elsewhere, their results are meaningless. They should therefore be considered as coming under the scope of physical models, it being noted that they most often apply to various classes of real-world object, material or otherwise.

Modeling allows in particular for “stress testing”, in other words assessing the behavior of a system when its environment subjects it to extreme conditions. It is therefore essential that the model remain valid under extreme conditions.

Modeling also permits the risks that aggregate A may run to be assessed. Known risk measures include volatility, or VaR (Value at Risk).

As already indicated, a first step in obtaining a risk measure of aggregate A consists in studying the statistical properties of the temporal series of total values VT(tₖ) and deducing from it a confidence interval of its variations. This approach, despite being often used, is clearly very limiting, because it is quite possible that the aggregate's recorded history includes no extreme situation, while they are perfectly possible.

A more advanced way of obtaining a risk measure, again according to prior art, consists in estimating the joint distribution of the leading parameters Yⱼ, and applying it to the function f( ). The joint distribution provides a “confidence region” of the multiplet of these leading parameters' values. Applying the function f( ) results in a confidence interval of the aggregate's value. The most unfavorable bound of this confidence interval is a risk measure, from which the VaR can be deduced.

The joint distribution of the leading parameters Y₁, Y₂, . . . Yⱼ, . . . Yₙ can be defined from the complete history relative to these leading parameters (contained in the first data). In general, the history is long and abundant. Be this as it may, in some domains, prior art simplifies matters by starting with reducing the historical information to only the dates tₖ of the Data2 data structures (dates where data exist for the aggregate(s)), and/or hypothesizing that the joint distribution of the leading parameters Yⱼ is a plain covariance matrix.

Modeling doesn't always work as one would wish.

To sum up, it is true that tracking the evolution of one or more well-chosen pseudo-aggregates makes it possible to model the evolution of a system, the study of which is based on one or more real-world phenomena. For a complex system, on the other hand, it is difficult, and in some cases thought impossible, for one or more of the following reasons:
scope of the system, and corresponding complexity of the data structures, with great variability in the possible sources of risk;
non-linearities and/or changes of regime, in the interactions that may occur;
the modeling needs to be robust under all circumstances, including the extreme;
delay effects between the source of risk and its observable impact on the system;
the desideratum that the modeling permit prediction, in other words reliably anticipating the behavior of the system analyzed according to movements on the leading parameters;
compliance with industrial norms of risk applicable to the domain.

As we have seen, there are numerous problems:
rigidity of the models, because the number of leading parameters must be limited if one wishes to avoid the difficulty of an under-specified problem;
instability of the calibration, because when two leading parameters temporarily have the same effect on the aggregate, the simulation could misunderstand their respective weights (phenomenon of colinearity);
too rough an approximation, resulting in too high a value of the residue Res;
poor predictive performances due to changes of regime, especially in extreme situations.

Moreover, it is not possible in any simple way to simulate the combination of several aggregates whose respective simulations use different parameters or sets of elements. The constraint of calibration stability imposes parsimony on the models, and a limited number of leading parameters must therefore be used for each aggregate. The choice of this limited set of leading parameters will differ for each aggregate; and it will no longer be possible to model a combination of aggregates in a homogeneous and reliable way using models of individual aggregates.

### DESCRIPTION OF THE INVENTION

The present invention is based on a certain number of observations.

Firstly, in the simplest (and commonest) situation, the leading parameters are quite simply a first set of real-world elements, having an influence on a second set of real-world elements (the two sets not necessarily being mutually exclusive).

This simplest and commonest situation underlies the prior-art approach, whereby it is possible to choose the leading parameters intuitively. Be this as it may, the intuitive approach is not necessarily exact.

In other words, knowledge of the leading parameters (the first set of elements) makes it possible to determine, in the main, the behavior of the second set's elements. The expression “in the main” means that, in principle, the behavior is known in a satisfactory percentage of possible situations (for example 95%), the remainder representing a residual risk acceptable and controllable by the user. In reality, it has been observed that the intuitive approach does not make it possible to obtain a residual risk acceptable and controllable by the user, because extreme situations are generally among the non-correctly modeled 5%.

In addition, a factor could exist (a leading-parameter candidate) which is not related to an element in the general situation, but only manifests itself when a particular scenario unfolds, specifically an extreme scenario. This type of influence goes hand in hand with, for example, a threshold effect, which could cause a change of regime.

In the case of a combination of aggregates (an “aggregate of aggregates”), the influence could be even more complex. The leading parameters may have only minimal influence on the individual aggregates, taken one by one; on the other hand, the synergy between certain individual aggregates could cause the set of parameters to have a serious impact on the combination of aggregates. Here, there is another threshold effect, related to the moment where the synergy in question appears, for example due to a change of correlations between the individual aggregates, or even between individual aggregates and certain leading parameters.

The present invention aims to take these types of particular situation, which often escape classic modeling, into account.

The Applicant has observed that at certain characteristic changes of regime, systematic correlation changes occur, and that it is possible to model them, especially in extreme situations.

The invention can be summarized as the implementation of all or part of four major stages:
the evaluation of relevance, or “scoring”, of each factor which is a leading-parameter candidate, followed by the selection of factors the relevance of which exceeds a certain threshold;
the estimation of possible evolution hypotheses for each selected leading parameter, in relation or not with certain hypotheses about the global environment;
the estimation of their impact on the aggregate according to the various hypotheses;
the global modeling itself for estimation of the risk and stress tests.

Parameters allowing for complementary calculations, such as those for the estimation of efficacy or expected returns, derive from risk estimation.

Risk estimation indeed provides mathematical data allowing the distribution of aggregate returns to be estimated. It is then possible to deduce an aggregate's expected performance and aim at optimizing the expected return with respect to the risk.

Selection of the Leading Parameters

For this, The Applicant proposes a completely different approach. The approach is illustrated in FIG. 3. It differs from FIG. 2 especially in the following: the ingredients chosen a priori to define the model are of two types, namely, identifiers of leading parameters (block 2150), and identifiers of generic expressions of corresponding functions Fⱼ (block 2160), to the tune of one per leading parameter. To facilitate the presentation, two separate blocks are represented in FIG. 3. In practice, identifier pairs can be stored:
(parameter function Fⱼ)

The word “function” refers here to a computer object. In computing, a function may be determined for example by:
the identification of a mathematical form, indicating it to be a linear combination for example, or a polynomial of degree d, or any other sort of mathematical form predefined by the system designer, and
a list of parameters or coefficients, consistent with the mathematical form designated by the identifier.

The above is known as a “parametric representation” of a function.

“Non parametric” representations can also be used, where the function Fⱼ is represented by a table of values (a “look-up table”), as well as by rules of interpolation between the values. In this case, what we here call a list of functions Fⱼ could include, for some at least, a list of look-up table identifiers.

There are also “semi-parametric representations” combining function-input look-up tables and a parametric representation of each interval or cell (in multidimensional cases) defined by the input look-up table.

The block selector 2150 is important. It must be sensitive to a wide variety of types of aggregate/parameter dependencies and, at the same time, minimize the risk a parameter be used erroneously, for example on an artifact, a chance effect or an error.

A special mode of performing the leading-parameters selection mechanism will now be described in reference to FIG. 4. After the input 410, the operation 412 establishes a very vast subset of the elements' universe SE, if not the totality of this universe.

In fact, an aggregate usually obeys rules of composition: only certain types of universe elements can be put there, and not others. These are the types of elements that need be considered as the above-mentioned “very vast subset of the universe SE”. The number of elements in this subset SE is noted NS, and written according to Formula [21] in the annex, with very large NS (typically NS>>100).

The next step is to evaluate each of the NS elements of subset SE. The operation 414 includes the selection of a first element. The operation 414 thus sets j=1. Then, the operation 420 works on the current element Yⱼ of subset SE.

We have a generic expression of a “non-linear dynamic” model F(Yⱼ), and will provide an example of this later. Here, “dynamic” means the existence of possible delay effects, whereas “non-linear” refers to, among other things, changes of correlations and threshold effects, it being understood that the class of “non-linear dynamic” models encompasses the more restrictive classes such as linear and/or static models (i.e. without delay effects).

We therefore search for a particular expression Fⱼ of the model F which best fits the variations of aggregate A as a function of the element Yⱼ. At the same time, we obtain a measure PVⱼ of the adjustment quality, here called p-value, and a residue Resⱼ. According to commonly accepted conventions, the p-value represents an estimation of the probability that the empirically-observed relation between the aggregate and the leading parameter is a pure effect of chance. Consequently, the better the fit, the smaller the p-value. A more detailed description of the p-value can be found here:
http://en.wikipedia.org/wiki/P-value

This is repeated for each of the parameters, by the incrementation of j in 422, and by the test 428 up until the end of the set SE (j=NS) is reached.

The various parameters are then sorted according to their respective p-values. The sorting corresponds roughly to the reliability of the influence observed on each parameter on the aggregate's global behavior. Typically, only the top-sorted are used, those whose p-values are below a threshold TH. The threshold TH can be set at the level that eliminates the erratic relations, at operation 430. Operations 440 to 448 form a loop which selects the elements to be used as effective leading parameters.

In the last phase (490), one is thus limited to a part PSE of subset SE. The number of PSE elements is noted NP, written according to Formula [22] in the annex, with NP≦NS.

Overall, aggregate A is thus modeled by a collection of NP expressions according to Relation [23] in the annex, where the Fⱼ and Resⱼ are those calculated above.

In other words, the selector (2150) interacts with the calibrator (2120), to adjust the particular functions on the said set (SE) of real-world elements. The leading parameters (Yⱼ) are then selected according to a selection condition, which includes the fact that the quality score (PVⱼ) obtained during the adjustment represents an influence which exceeds a minimum threshold (TH).

The technique described in reference to FIG. 4 can be seen as a collection of mono-factorial analyses, which performs both the selection of leading parameters within the initial set SE, by attributing them with a measure of reliability, and the determination of the models Fⱼ with their respective residues Resⱼ. Nevertheless, it is still possible to disconnect the roles of the selector (2150) and calibrator (2120).

The process is entirely automatic. Determining the threshold TH can be done automatically, at a fixed value, 5% for example, or even at a value adjusted according to the number NS. It may be necessary to adjust the threshold in certain cases at least. In particular, according to one variant of the invention, the threshold TH can be “post-adjusted” entirely automatically, according to an algorithm taking the series of p-values obtained for the various leading parameters Yⱼ into account.

It may occur that a recently-appearing or -created aggregate includes certain heterogeneous real-world elements which are older than the aggregate. In this case, one can proceed as follows:
a. the short history of the aggregate is used to select the relevant leading parameters,
b. a model is thus calibrated according to Relation [23].

So, for each leading parameter Yⱼ, of which one has a very long history, one estimates its most probable distribution in the near future, which will be used for applying the model later in order to gain a good estimation of the aggregate's values' future distribution (for example the fund returns).

In other words, the simulation generator (2100) is arranged to select the leading parameters (Yⱼ) by limiting itself to an available recent historical tranche for the aggregate (A), but applying the corresponding particular function (Fⱼ) to the most probable future distribution of the leading parameters, according to its complete history.

Elsewhere, the collection of expressions according to Relation [23] can be used in various applications.

Hence, the system can be completed by a constructor of simulated real-world states (3200), as well as a motor (3800) arranged to apply the collection of models relative to the aggregate (2700) to the said simulated real-world states, in order to determine at least one output magnitude relative to a simulated state (3900) of the aggregate (A), dependent upon an output condition. Preferably, but not exclusively, the output condition can be defined or chosen to form a risk measure.

Estimation of the “Stress VaR”

A way 510 of using the model is illustrated in FIG. 5.

In these implementation modes, the constructor of simulated real-world states (3200) is arranged to generate a range of possible values for each leading parameter (Yⱼ), and the motor (3800) is arranged to calculate the transforms of each possible value of each range associated with a leading parameter (Yⱼ), each time by means of the particular function (Fⱼ) corresponding to the leading parameter (Yⱼ) in question, whereas the said output magnitude relative to a simulated state (3900) of the aggregate (A) is determined by analysis of the set of transforms, depending on the said output condition.

We also have (531), as mentioned earlier, historical data on the Yⱼ. From this we deduce, for each Yⱼ, an individual confidence interval CIⱼ=[CIⱼ⁻, CIⱼ⁺] with a certain degree of confidence determined in advance c which represents the probability that the leading parameter remains within the confidence interval, as indicated in Formula [24]. There are in fact two variants: one where the confidence interval of Yⱼ depends only on its history, and one where it also depends on the history of the other Yⱼ.

According to a first variant, determination of the confidence interval CIⱼ uses only the historical data of the parameter Yⱼ. To do so, a probability distribution of the values of Yⱼ(t) or of variations of these values is estimated, perhaps by calibrating a model of temporal series (such as those described in C. Gouriéroux, op. cit.), then the distribution's “percentiles” at probabilities c and 1−c are determined.

According to a second variant, the history of all, or some, elements in the Data1 data structure is used to calibrate a model of these parameters' dynamic evolution, making it then possible to deduce the probability distribution of the values of Yⱼ and the confidence interval CIⱼ. This stage could possibly use the pseudo-random simulation (known as “Monte Carlo” simulation) of values of all or part of the elements of the Data1 data structure, then of the parameter Yⱼ as described below.

Operations 512 to 528 form an individual processing-loop for each of the leading parameters Yⱼ.

Knowing the individual confidence interval CIⱼ=[CIⱼ⁻, CIⱼ⁺] of Yⱼ, one knows how to establish in 514 a range of values of Yⱼ covering this confidence interval with enough precision for the values of the functions Fⱼ evaluated at the points of this range to provide a reliable measure of the risk of the aggregate related to this leading parameter, following the procedure described below. This can be for example a sample, at regular intervals or not, of the leading parameter's values. It can also result from a pseudo-random simulation of the values, for example the one used to calculate the bounds of the interval CIⱼ.

We shall now consider the individual model Fⱼ( ) of the aggregate with respect to the leading parameter Yⱼ.

In 520, applying this model to the said range of values of Yⱼ made it possible to deduce a confidence interval FCIⱼ=[FCIⱼ^{-, FCI}ⱼ⁺] for the aggregate (based on the model Fⱼ and interval CIⱼ) according to Formula [25]. To this needs adding the uncertainty Eⱼ related to the residue Resⱼ according to Formula [26].

In 530, the combination of these confidence intervals FCIⱼ for all the leading parameters (selected in the set PSE) provides a global confidence interval FCIₘₐₓ attributed to the aggregate, according to Formula [27], always with respect to the above-mentioned degree de confidence c.

Basically, the most unfavorable bound of the latter interval (lower or upper according to context) represents a risk measure of the aggregate A, with the final result in 534.

This measure can be called “Stress VaR”, while the most unfavorable bounds of the various intervals Fⱼ(CIⱼ), in other words (according to Formula [26]) the intervals [Kⱼ⁻, Kⱼ⁺] in which the residual uncertainty Eⱼ is not taken into account, are called “Stress VaR attached to the risk Yⱼ”. The reason for not taking the residual uncertainty into account is that in numerous cases the specific impact of parameter Yⱼ as source of risk needs to be known.

More generally, several global confidence intervals FCIₘₐₓ(c) can be determined for different values of c, and a probability distribution of the aggregate value be derived, allowing calculation of more complex risk measures. See for example the article by P. Artzner et al. “Coherent risk measures”, Mathematical Finance 9, 1999, No. 3, 203-228.

In this implementation mode, the constructor of simulated real-world states (3200) is arranged to generate, for each leading parameter Yⱼ, a range of possible values covering the confidence interval of the leading parameter Yⱼ in question, in that the motor (3800) is arranged to calculate the transforms of each possible value of each range associated with a leading parameter Yⱼ, each time by means of the particular function Fⱼ corresponding to the leading parameter Yⱼ in question, to try and derive each time a confidence interval of the aggregate A in the light of the leading parameter Yⱼ in question, and in that the said output condition includes a condition of extremity, applied to the set of confidence intervals of the aggregate A for the various leading parameters Yⱼ.

Variants of FIG. 5 are possible, including the following:
In the block 514, one takes not only a set of possible values Yᵢⱼ of the leading parameters Yⱼ, but also the probability pᵢⱼ of each value Yᵢⱼ;
In the block 521, in addition to calculating the aggregate's confidence interval, a set of possible values of the aggregate Xᵢⱼ=Fᵢ(Yⱼ), with corresponding probabilities pᵢⱼ, is determined;
In the block 530, one or more statistical functions are applied to the values Xᵢⱼ, for example a mean weighted by the probabilities;
In the block 534, one thus obtains from values of the statistical functions obtained for each leading parameter an estimation of the expected value of the aggregate, absolutely, or relative to its current value.

This variant illustrates in particular the way of estimating the performance of an aggregate, as described earlier.

Weighted Monte Carlo

As mentioned above, a variant consists in simulating the joint distribution of the Yⱼ by a pseudo-random series of size M having the statistical properties of the historical series in question, or the statistical properties determined according to a dynamic model of temporal series, chosen according to the situation.

Here too one obtains a range of values for each leading parameter Yⱼ made up of simulated pseudo-random values.

This simulation is represented as a rectangular matrix of the order N×M. The current element of this matrix, m=1 . . . M, is noted and Y_{j,m}, Fⱼ(Y_{j,m}) is calculated, to which a contribution Res_{j,m}, randomly derived from the residue Resⱼ, can be added.

Moreover, through the p-value PVⱼ we obtain a “score” Sⱼ of each Yⱼ. This score, which we may assume to be within the interval [0,1], will be higher (i.e. close to 1) the lower the p-value PVⱼ is (i.e. close to 0).

The choice of the function H(PV) attributing a score Sⱼ to the p-value PVⱼ will be done depending on context, and complying with the following constraints:

H(PV)=0 if PV≧TH

H(0)=1

0<H(PV)<1 if 0<PV<TH

Here, the constructor of simulated real-world states (3200) is arranged to generate, for each leading parameter (Yⱼ), a range of possible values established pseudo-randomly from the joint distribution of the leading parameters (Yⱼ); the motor (3800) is arranged to calculate the transforms of each possible value of each range associated with a leading parameter (Yⱼ), each time by means of the particular function (Fⱼ) corresponding to the leading parameter (Yⱼ) in question; and the output condition is derived from an extreme simulation condition applied to the set of transforms.

According to one variant, the function H and threshold TH may differ according to the chosen leading parameter Yⱼ depending on the fine statistical properties of the parameter's historical series (for example, the threshold TH can be caused to depend upon the series' autocorrelation, as is recommended in several works on econometrics, such as that of Hamilton mentioned above).

If we now consider the global series of N×M values Fⱼ(Y_{j,m})+Res_{j,m} as a weighted pseudo-random series of the aggregate values, the weights being proportional to the scores Sⱼ, we obtain the simulation of a random distribution, the “percentiles” of which provide the risk measure of the aggregate A being sought.

A sub-variant of this technique consists in searching, in the past, periods where the combined statistic of the leading parameters Yⱼ is close to that of the parameters' recent evolution, and over-weighting, if not only selecting, the periods following these periods which are similar to the recent past as a more reliable model of the near future.

As variant of this sub-variant, one could also attribute to each leading parameter a coefficient influenced by the elements' evolution. These coefficients would then multiply the scores to obtain the weights of the various leading parameters, respectively. This makes it possible to avoid over-weighting the leading parameters which are highly correlated among each other and the repetition of which would obfuscate other major sources of risk.

Another variant consists in mathematically deducing a multifactorial model of the aggregate with respect to the set of Yⱼ, starting from the collection of individual models Fⱼ, and the joint distribution of the Yⱼ. The mathematical algorithm of the multifactorial model is described in the following article: R. Douady, A. Cherny “On measuring risk with scarce observations”, Social Science Research Network, 1113730, (2008), to which the reader is invited to refer.

This technique will now be described in greater detail in reference to FIG. 6. In 610, we have the history of the Yⱼ (Data1), the joint distribution of which can be deduced in 612. At the same time, in 620, we have the collection of models Fⱼ(Yⱼ) for all the selected leading parameters. From blocks 612 and 620, we can derive in 630 a joint model V=f(Y₁ . . . Yₙ). From the joint distribution of the Yⱼ in 612, we can derive in 632 a simulation of the values of the Yⱼ. Starting from the blocks 612 and 620, the operation 640 can now apply the said joint model to the vector of the simulated values of the Yⱼ.

In other words, the motor (3800) is arranged to first establish a joint multifactorial model of the aggregate A, from the collection (2700) of mono-factorial models relative to the aggregate A, and the joint distribution (2700) of the leading parameters Yⱼ of the aggregate A, to be able then to work on the said joint model.

Prior-art techniques then apply for obtaining the confidence interval, as risk evaluation in 690.

Stress Tests

The above variants concern a confidence interval, which is a “risk figure” for the aggregate. One might wish to perform a “stress test”, in other words known the possible impact of a particular scenario, especially for satisfying certain industrial norms. The Yⱼ are thus simulated, but subject to the condition of this particular scenario, in other words that the distribution of the Yⱼ is voluntarily biased by the hypothesis of executing the desired scenario.

This technique will now be described in greater detail in reference to FIG. 7. In 710, we have the history of the Yⱼ (Data1), the joint distribution of which can be deduced in 722, but this time, conditionally upon a stress, here defined by a set of stress values for the Yⱼ (720). Moreover, in 730, we have the collection of models Fⱼ(Yⱼ) for all the selected leading parameters. From blocks 722 and 730, we can derive in 740 a joint model V=f(Y₁ . . . Yₙ). Starting from the blocks 720 and 740, the operation 750 can now apply the said joint model to the vector of the simulated values of the Yⱼ, defined here by the set of stress values for the Yⱼ (720).

In this variant, the constructor of simulated real-world states (3200) is arranged to generate an expression of stress condition for each leading parameter Yⱼ; and the motor (3800) is arranged to establish first the joint distribution (2700) conditionally upon the said expression of stress condition for the leading parameters Yⱼ of the aggregate A, then to establish a joint multifactorial model of the aggregate A, from the collection (2700) of mono-factorial models relative to the aggregate A, and of the said conditional joint distribution (2700) of the leading parameters Yⱼ of the aggregate, and then to work on this joint model.

The prior-art techniques (on multifactorial models obtained in a different manner) then apply for performing an evaluation of the stress test in 790. Here it is possible to calculate the confidence intervals, as before, as well as the mean value (conditional expectation).

Two types of stress tests can be considered:
“Deterministic” stress tests, in which the behavior of the environment is fully described in a precise scenario, in other words one gives oneself precisely the values (or variations of the values) SYⱼ of all the leading parameters Yⱼ (as in FIG. 7). One then tries to estimate the behavior of the aggregate according to this hypothesis. Mathematically, it is the conditional expectation of the value or variation of the value of the aggregate subject to the condition of this particular scenario being performed.
“Random” stress tests, in which the behavior of the environment is only partially described, either that only the value (or variation of the value) of certain elements is specified, the others needing to be estimated, or that the values of the leading parameters are specified imprecisely, by an interval, by a probability distribution given by a formula or even by a probability distribution given by a pseudo-random simulation (so-called “Monte Carlo”).

In the case of “random” stress tests, such as for calculating the VaR, we will have a random representation of the aggregate, of which we are trying to determine a risk measure. The only difference with a conventional risk measure is due to the fact that the probability distribution assumed for the leading parameters is voluntarily biased by the hypothesis that a scenario—precise or imprecise—occurs on all or part of the leading parameters, or even on certain elements of the environment.

According to a first variant of deterministic stress test, for each leading parameter Yⱼ selected, the function Fⱼ is applied to the specified value SYⱼ of the leading parameter according to the stress test. One thus obtains a collection of stressed values of the aggregate Fⱼ(SYⱼ), from which will be chosen the most unfavorable of the parameters the p-value PVⱼ of which is below a certain threshold.

A special case of this variant is when one chooses only the leading parameter with the smallest p-value: the threshold equal to this smallest p-value needs then to be set.

According to a second variant, the mono-factorial models are “merged”, in other words, based on the mono-factorial models Fⱼ corresponding to each of the selected leading parameters, a multi-variate model is calculated, according to the same principle as that applied above for calculating the “Stress VaR”, for example by the approach developed in the Douady-Cherny article mentioned above.

Merging linear models to obtain a linear multi-variate model using the covariance matrix of the leading parameters is a special case of the model in the above-mentioned Douady-Cherny article. To implement this approach correctly, a matrix of covariances conditional upon the stress test performed should be used, which can for example be estimated using the so-called “LOESS regression” procedure. For more information, see:
http://en.wikipedia.org/wiki/Loess regression

According to a third variant, the stress test is random, implying that the stress values SYⱼ of the leading parameters Yⱼ are not given with precision; only an interval of possible values is given. In this case, for each leading parameter, a range of values covering the interval specified will be chosen and the most unfavorable of the values obtained from among the leading parameters the p-value PVⱼ of which is below a certain threshold will be attributed to the stress test.

According to a fourth variant, instead of possible value intervals, a joint probability distribution of the leading parameters is provided. In this case, the probability distribution will be represented by a pseudo-random simulation (“Monte Carlo”) and the stress test will be determined either as a weighted mean of the values obtained by applying the mono-factorial models Fⱼ (to which one could perhaps add a randomly simulated value of the residue Resⱼ), or by a risk measure, for example a percentile, of the values' distribution. The weighting could involve the scores Sⱼ calculated from the p-values PVⱼ.

According to a fifth variant, the stress test is, in the sense described above, qualified as random, but defined by the data—precise or imprecise—of the value or variation of the value of one or more elements of the Data1 data structure, the elements being or not being leading parameters of the random event. In this case, one would estimate (by a “Loess regression” procedure for example, although other approaches are possible) the joint distribution of the selected leading parameters conditionally upon the specified values of the identified element(s). The procedure described in the fourth variant above is then applied.

Generally, the simulation generator (2100) can be arranged to enable specification of one or more element-identifiers from the data structure (Data1), as well as the stress values for these elements, then estimation of the most probable future distribution of the leading parameters (Yⱼ), conditionally upon these stress values. Then, for example, one could overweight the historical dates according to proximity of the element-magnitudes or their variations (at a historical date) with the stress values specified.

In the above, a number of parameters Yⱼ to which the fund is sensitive have been identified. And calibration according to Relation [21] has been possible.

It might be interesting to take a more global parameter into account, such as for example the index called CAC40 in France, which represents the overall market trend.

But it may well be that a reliable relation between the global index and the aggregate in question (a financial fund) has not been identified. In this case, the global index will not appear among the leading parameters Yⱼ chosen for the modeling.

It might still be tempting to try and perform a calibration on the global index (which we note as Yₛₚ₁), in the form:

R=Fₛₚ₁(Yₛₚ₁)+Resₛₚ₁

However, the Applicant has observed that, in situations where there is poor correlation between the evolution of the fund and that of the global index, the function Fₛₚ₁(Yₛₚ₁) will be almost flat. Consequently, the risk for the fund resulting from a severe drop in the market, for example if the CAC40 were to drop by 20%, would by seriously under-estimated. It is therefore proposed to proceed as follows:
i) choose a target variation figure, downwards in principle, for example 20%,
ii) seek and identify, from a very long-term history, samples (dated) where the global index (CAC40) has dropped a lot (but distinctly less than 20%),
iii) attribute to each of the samples a weight related to the proximity between the real drop and the target figure of 20%,
iv) then, for each parameter selected, generate a Monte Carlo series having the statistical properties of the factor's historical series taking the weighting into account,
v) apply the factor's function Fⱼ to the factor's Monte Carlo, which gives a distribution of the fund's series with respect to the factor,
vi) deduce from it a Stress VaR for this factor, and
vii) determine the maximum of the various measures with respect to the leading parameters, which gives a global risk figure.

This can be seen as the performance of a stress test using the Monte Carlo method calibrated on a weighted history.

Examples of Implementation

The invention applies particularly to dimensioning constructions to resist seismic tremors. Various types of seismic wave are known: body waves such as P-waves (compressional) and S-waves (shear), ground rolls or surface waves such as LQ (Love/Quer) and LR (Rayleigh), etc.
http://en.wikipedia.org/wiki/Earthquake

Prior art would simulate the impacts of different types of wave separately. This is not enough, because the combined effect of two different wave types may prove worse than the sum of their individual effects.

In this case, the invention makes it possible to individually simulate a large number of possible wave combinations. For each combination, the “model function” is calibrated empirically over the set of minor tremors observed, then the function is extrapolated, according to a predetermined structural model, to anticipate the impact of a tremor of an amplitude specified by antiseismic norms, again in the direction of the chosen combination.

A second implementation of the invention concerns the simulation of risks in financial investment, for example in mutual funds.

According to prior art, modeling the fund's returns will be based upon a certain number of financial indices, as a linear combination of the indices' returns. This form of modeling is unsuitable when financial markets undergo strong fluctuations, if not crises, because the coefficients of the linear combinations no longer apply to such exceptional circumstances. Moreover, it may become necessary incorporate into the linear combination one or more indices which were not there before.

Thanks to the invention, a very large number of stock-market indices may be taken into consideration; the “model function” attached to each will be estimated, even when the indices have only a minor impact under normal market conditions; the function is then extrapolated, to anticipate the impact of an exceptional circumstance; as concerns modeling the environment, such an exceptional circumstance can be specified as a function of historically-recorded economic or financial crises, or anticipated by contemporary economic research, for example.

For example, it will be remembered that during the so-called “subprime” crisis of the summer of 2007, a certain number monetary funds, having invested in so-called “toxic” products without declaring them, lost up to 20% of their value, causing immense economic difficulties to numerous industrial enterprises whose cash is typically invested in this type of financial product.

According to prior art, without simulating the environment, it will appear that the fund in question had never encountered losses prior to the crisis. The model will thus consider such as loss as impossible.

According to type of prior art, in which the environment is simulated with the help of a function that is a linear combination of indices, monetary funds naturally use indices corresponding to short-term interest rates and, possibly, certain credit indices (e.g. “credit spread”). Under normal market conditions, the fund is essentially subject to short-term interest rates, and very little affected by credit spread. Even an extreme simulation of these parameters (for example the values observed during the Russian crisis mentioned below) will not take the effect of credit spread into account and, consequently, losses will again be considered as negligible, if not impossible.

Thanks to the invention, for each credit index, a respective non-linear “model function” will be estimated. For modeling the environment, fluctuations in credit indices observed during the 1998 crisis (Russian crisis) will be taken into account. Applying the non-linear function to each of these indices, and taking the worst case obtained into account, makes it possible to anticipate the losses which were observed shortly afterwards.

The table below shows the mean performances of monetary funds, all considered by prior art as little- or unrisky, according to whether the invention identified them as risky or not.

| Degree of risk | | |
|---|---|---|
| (seen by the | | |
| invention) | Low | High |
| Number of funds | 93 | 29 |
| Real losses | −0.32% | −2.34% |
| Anticipated losses | −0.30% | −1.63% |

Classes of Risk

The universe of leading parameters SE can be classified into several sub-categories SEᵢ, i=1 . . . p. The “risk” deriving from each of these sub-categories can then be differentiated by performing the preceding calculation on each subset SEᵢ by not including the residual uncertainty Eⱼ. The result obtained will be called the “Stress VaR attached to the risk of the class SEᵢ”.

The impact of an abrupt variation occurring on one or more leading parameters of this class can thus be estimated.

Take for example a construction, subject to meteorological risks and seismic risks, both the object of industrial norms. Dimensioning of the construction elements will be done depending upon maximum admissible constraints, according to a certain degree of confidence. To do so, one determines the “Stress VaR” on the set of risks to which the construction is subjected. If a technical constraint is revised in one of the norms (maximum admissible wind for example), the calculation of the “Stress VaR attached to the risk of the class SEᵢ” corresponding to the revised norm (for example the risk related to different modes of wind) will also need to be revised.

“Variations/Levels” Alternative

In the above, it was implicitly considered that the leading parameters represent measurable physical magnitudes. And the model functions provide the value of the aggregate.

One variant works on variations. In this case, a leading parameter is calculated as the variation of a physical magnitude at a determined rate (for example sampling rate). The variation can be an absolute deviation, or a relative deviation, as a percentage for example.

Likewise, the model function will represent the variations (absolute or relative) of the aggregate value, which will be added to the current value, if necessary.

Mixed cases may be used:
the model functions represent variations of aggregate values, but certain leading parameters are directly physical magnitudes while others are magnitude variations.
the model functions represent values of the aggregate themselves, and again, certain leading parameters are directly physical magnitudes while others are magnitude variations.

Estimation of the p-value

A key point of the invention is estimation of the p-value, which determines selection or not of the aggregate's leading parameters. Here, we give the principles of the estimation and two examples of algorithmic procedures leading to the estimation.

The relevance of a given leading parameter Yⱼ can be evaluated by comparing two models:
One model, called “null hypothesis”, uses only past values of the aggregate to “explain”, in other words anticipate, its future values, as if the leading parameter Yⱼ had no influence.
The other model, called “alternative hypothesis”, includes a generic form of the function Fⱼ, the coefficients of which are to be estimated.

By definition, the “p-value” is the probability that, assuming the null hypothesis, one has obtained the sample observed and, consequently, estimated the coefficients of the function Fⱼ according to the alternative hypothesis and obtained the values found. The principle of estimating the p-value thus consists in evaluating the uncertainty on the vector of Fⱼ coefficients, assuming the null hypothesis, then estimating the probability of estimating a vector at least as far from the null vector (corresponding to the null hypothesis) than that empirically obtained from the sample.

According to a first variant, the p-value is estimated by the Fischer procedure known as “F-test”. The Fischer statistic related to this test, traditionally noted “F” but which we will here note FI to avoid confusion with other variables, exists in all versions of the Microsoft Corporation Excel® software program as optional output of the “LinEst( )” function (create a regression line). Its principle consists in a mathematical processing of the comparison between the “R2” of the regression according to the null hypothesis, which may be noted R2₀ and the one obtained by the alternative hypothesis, which may be noted R2ₐₗₜ. The function transforming the Fischer statistic FI into p-value PV also exists in the Excel® software package under the name FDist( ) and involves, among others, the number of regressors and sample size. An explicit formulation of the Fisher statistic FI is found in the article:
http://en.wikipedia.org/wiki/F-test

Hamilton (op. cit.) suggests other procedures: the Wald test, the “likelihood function”, etc.

In his work “Small sample econometrics”, Lutkepol warns against estimation bias when sample size is limited and proposes various corrective measures, either in the form of mathematical formulas involving samples' higher-order moments, or numerous empirical tables, established to assist in pseudo-random simulations.

In the work “Cointegration”, Madala conducted very exhaustive research of the literature under the topic of error correction models (ERM), also known as “cointegration”.

Nevertheless, all these approaches come under the heading of multi-variate linear regression on the values or variations of the values of the aggregate and leading parameters, or even mixed models combining values and variations in the case of cointegration.

Now, we have seen that non-linearity can be an important characteristic of the invention for taking the risk of extreme situations correctly into account.

The Applicant proposes a different and innovative approach, although known in other settings under the name of “bootstrapping”. According to this variant, to estimate the uncertainty of the model calibrated under the null hypothesis, but preserving the statistical properties of the aggregate sample and leading parameter, a “permutation” gₘ, m=1 . . . M of the temporal indices k of the history of tₖ is randomly drawn.

According to a second variant, one generates M pseudo-random samples of dates gₘ(k), k=0 . . . F (in the case of values) or k=1 . . . F (in the case of variations), and m=1 . . . M (these samples may or may not be subjected to constraints such as gₘ(k)≠gₘ(k′) for k≠k′ or gₘ(k)≠k, or even impose a minimum difference depending upon the delay effect tolerated by the model). For each draw m, the temporal series of regressors specific to the alternative hypothesis Yⱼ(tₖ) is replaced by Yⱼ(t_{gm(k)}) and one thus obtains a value R2ₘ and a Fischer statistic FIₘ. Based on this sample of values, one estimates, parametrically or purely empirically, a probability distribution on the real half-line and calculates the probability of exceeding the value FIₐₗₜ calculated from the R2₀ of the null hypothesis and the R2ₐₗₜ of the alternative hypothesis (with non-randomized dates). This probability will be our estimation of the p-value PVⱼ.

According to a sub-variant, the “drawings” of indices gₘ are not pseudo-random, in other words do not use a computerized random-number generator, but are obtained by a deterministic and identically-repeatable algorithm, for example the one described by the following formula:

gₘ(k)=aₘk+bₘ(mod F)

where aₘ describes a subset of the set of integer numbers first at the number F of dates in the sample and bₘ a subset of the set {0, . . . , F−1} the size of which depends upon the number of M draws desired. Other deterministic algorithms are possible, particularly for taking into account the constraints imposed upon draws of indices gₘ.

This sub-variant, which may be qualified as “deterministic bootstrap” makes it possible to compare the p-values of different leading parameters without the comparison containing a random element. It is more reliable than specifying a “seed”, common to various pseudo-random draws.

In the detailed description above, for simplicity's sake, we spoke of “value” for a real-world element, as well as for an aggregate of such elements. It is generally the value of an intensive magnitude which characterizes the element. In principle, the elements of a given aggregate have respective values bearing on the same intensive magnitude.

More generally, particularly in the claims below, we designate by “magnitude” any measurable value relative to a physical real-world element. By “physical real-world element” we mean any element present in the real world, be it material or immaterial. Likewise, an aggregate is a set of real-world elements, material or immaterial. An element can be created by nature or by man, on condition its evolution is not entirely controlled by man.

The invention is not limited to the examples of the above-described system, used purely for purposes of illustration.

The present invention can also be expressed in the form of procedures, particularly with reference to the operations defined in the description and/or appearing in the drawings of the Annex. It may also be expressed in the form of computer programs, capable, in cooperation with one or more processors, of implementing the said procedures and/or be part of the simulation devices described for running it.

Annex 1

$$\begin{matrix}1. Bases & \\ Data 1 = \{ id , V , t \} & ( 1 ) \\ Data 2 = \{ Data 1 ( {t}_{0} ) , Data 1 ( {t}_{1} ) , … , Data 1 ( {t}_{q} ) , … , Data 1 ( {t}_{F} ) \} & ( 2 ) \\ \{ Data 2 , id \} = \{ ( {V}_{0} , {t}_{0} ) , ( {V}_{1} , {t}_{1} ) , … , ( {V}_{k} , {t}_{k} ) , … , ( {V}_{F} , {t}_{F} ) \} & ( 3 ) \\ {E}_{i} = \{ Data 2 , id \} {V}_{i} ( t ) = \{ {V}_{k} \vert k = 0 … F \} & ( 4 ) \\ {A}_{p} ( {t}_{0} ) = \{ {id}_{i} ( {t}_{0} ) , {q}_{i} ( {t}_{0} ) , {V}_{i} ( {t}_{0} ) \} i = 1 … Card {A}_{p} ( {t}_{0} ) & ( 5 ) \\ VT ( {A}_{p} ( {t}_{0} ) ) = {\sum }_{i = 1}^{{CardA}_{p} ( {t}_{0} ) } {q}_{i} ( {t}_{0} ) {V}_{i} ( {t}_{0} ) & ( 6 ) \\ {W}_{i} ( {t}_{0} ) = \frac{{q}_{i} ( {t}_{0} ) {V}_{i} ( {t}_{0} )}{VT ( {A}_{p} ( {T}_{0} ) )} & ( 7 ) \\ {A}_{p} ( t ) = V ( t ) ⊗ Q ( t ) = \{ {V}_{i} ( t ) , {q}_{i} ( t ) \} i = 1 … Card {A}_{p} ( t ) & ( 8 ) \\ Data 3 = \{ {A}_{p} ( {t}_{k} ) \} k = 1 … F & ( 9 ) \\ Data 4 = \{ B ( {t}_{k} ) \} k = 1 … F & ( 10 ) \\ B ( t ) = \{ {w}_{p} ( t ) , {A}_{p} ( t ) \} p = 1 … Card B ( t ) & ( 11 ) \\ f ( {y}_{1} , … , {y}_{j} , … , {y}_{m} ) = {\sum }_{j = 1}^{n} {a}_{j} {y}_{j} & ( 12 ) \\ VT = f ( {Y}_{1} , {Y}_{2} , … , {Y}_{j} , … , {Y}_{n} ) + Res \\ 2. Functions & ( 13 ) \\ SE = \{ {Y}_{1} , {Y}_{2} , … , {Y}_{j} , … , {Y}_{NS} \} NS >> 100 & ( 21 ) \\ PSE = \{ {Y}_{j} ; j = {j}_{1} , … , {j}_{NP} \} NP \leq NS & ( 22 ) \\ VT = {F}_{j} ( {Y}_{j} ) + {Res}_{j} j = {j}_{1} , … , {j}_{NP} & ( 23 ) \\ Pr [ {CI}_{j}^{-} \leq {Y}_{j} \leq {C}_{j}^{+} ] = c j = {j}_{1} , … , {j}_{NP} & ( 24 ) \\ {FCI}_{j} = [ {FCI}_{j}^{-} , {FCI}_{j}^{+} ] j = {j}_{1} , … , {j}_{NP} & ( 25 ) \\ {F}_{j} ( {CI}_{j} ) = [ {K}_{j}^{\_} , {K}_{j}^{+} ] {FCI}_{j}^{-} = {K}_{j}^{-} - {E}_{j} {FCI}_{j}^{+} = {K}_{j}^{+} + {E}_{j} & ( 26 ) \\ {FCI}_{max} = [ {min}_{{j}_{1} … {j}_{NP}} ( {FCI}_{j}^{-} ) , {max}_{{j}_{1} … {j}_{NP}} ( {FCI}_{j}^{+} ) ] & ( 27 )\end{matrix}$$

1-19. (canceled)

20. A system for a computerized simulation of an evolving real-world aggregate, the device comprising:
a memory configured to store:
basic data relative to the history of real-world elements, these basic data include the data structures, proper, for a given real-world element, to establishing an element-identifier, as well as a series of element-magnitudes corresponding to the respective element-dates; and
aggregate data, where each aggregate is defined by groups of element-identifiers, each group being associated with a group-date, whereas an aggregate magnitude can be derived from element-magnitudes corresponding to the group's element-identifiers, at each group-date, and
a simulation generator configured to establish a computer model relative to an aggregate,
wherein, for a given aggregate, said simulation generator is configured to match particular functions to respective leading parameters, selected for the aggregate in question, each particular function resulting from adjustment of the history of the aggregate magnitude with respect to the history of its respective leading parameter, up to a residue, the adjustment being attributed a quality score, and
in that the model relative to aggregate includes a collection of mono-factorial models, defined by a list of leading parameters, a list of corresponding particular functions and their respective quality scores.

21. The system according to claim 20, wherein the simulation generator includes:
a selector, capable, upon designation of an aggregate, of parsing a set of real-world elements defined in the basic data, and selecting from it leading parameters according to a selection condition, one which includes the fact that a criterion of leading parameter influence on the aggregate represents an influence exceeding a minimum threshold, and
a calibrator, arranged to make the respective particular functions correspond to each of the selected leading parameters, each particular function resulting from adjustment of the history of the aggregate magnitude compared to the history of the relevant leading parameter, up to a residue, the adjustment being attributed a quality score.

22. The system according to claim 21, wherein the selector interacts with the calibrator, to adjust the particular functions on the said set of real-world elements, to then select the leading parameters dependent upon the said selection condition, whereas this same selection condition includes the fact that the said quality score obtained during the adjustment represents an influence which exceeds a minimum threshold.

23. The system according to claims 21, wherein the calibrator operates to establish the said particular functions as from a set of expressions of generic functions of unknown coefficients.

24. The system according to claim 23, wherein the set of expressions of generic functions of unknown coefficients includes expressions of non-linear generic functions.

25. The system according to claim 20, wherein it also includes a constructor of simulated real-world states, as well as a motor arranged to apply the collection of models relative to the aggregate to the said simulated real-world states, in order to determine at least one output magnitude relative to a simulated state of the aggregate, dependent upon an output condition.

26. The system according to claim 25, wherein the output condition is chosen to form a risk measure.

27. The system according to claim 25, wherein the constructor of simulated real-world states is arranged to generate a range of possible values for each leading parameter, in that the motor is arranged to calculate the transforms of each possible value of each range associated with a leading parameter, each time by means of the particular function corresponding to the leading parameter in question, whereas the said output magnitude relative to a simulated state of the aggregate is determined by analysis of the set of transforms, depending on the said output condition.

28. The system according to claim 27, wherein the constructor of simulated real-world states is arranged to generate, for each leading parameter, a range of possible values covering the confidence interval of the leading parameter in question, in that the motor is arranged to calculate the transforms of each possible value of each range associated with a leading parameter, each time by means of the particular function corresponding to the leading parameter in question, to try and derive each time a confidence interval of the aggregate in the light of the leading parameter in question, and in that the said output condition includes a condition of extremity, applied to the set of confidence intervals of the aggregate for the various leading parameters.

29. The system according to claim 27, wherein the constructor of simulated real-world states is arranged to generate, for each leading parameter, a range of possible values established pseudo-randomly from the joint distribution of the leading parameters, in that the motor is arranged to calculate the transforms of each possible value of each range associated with a leading parameter, each time by means of the particular function corresponding to the leading parameter in question, and in that the output condition is derived from an extreme simulation condition applied to the set of transforms.

30. The system according to claim 25, wherein the motor is arranged to first establish a joint multifactorial model of the aggregate, from the collection of mono-factorial models relative to the aggregate, and the joint distribution of the leading parameters of the aggregate, and then to be able to work on the said joint model.

31. The system according to claim 30, wherein the constructor of simulated real-world states is arranged to generate an expression of stress condition for each leading parameter, and in that the motor is arranged to establish first the joint distribution conditionally upon the said expression of stress condition for the leading parameters of the aggregate, then to establish a joint multifactorial model of the aggregate, from the collection of mono-factorial models relative to the aggregate, and of the said conditional joint distribution of the leading parameters of the aggregate, and then to work on this joint model.

32. The system according to claim 20, wherein the simulation generator is arranged to establish a quality score by the so-called “F-test” procedure.

33. The system according to claim 20, wherein the simulation generator is arranged to establish a quality score by the so-called “bootstrap” procedure.

34. The system according to claim 20, wherein the simulation generator is arranged to establish a quality score by the so-called “deterministic bootstrap” procedure.

35. The system according to claim 20, wherein at least some of the leading parameters are taken into account by their variations in the corresponding particular function.

36. The system according to claim 20, wherein at least some of the particular functions express the variation of the aggregate-magnitude.

37. The system according to claim 20, wherein the simulation generator is arranged to select the leading parameters by limiting itself to an available recent historical tranche for the aggregate, but applying the corresponding particular function to the most probable future distribution of the leading parameters, according to its complete history.

38. The system according to claim 20, wherein the simulation generator is arranged to enable specification of one or more element-identifiers among the data structure, as well as the stress values for these elements, then estimation of the most probable future distribution of the leading parameters, conditionally upon these stress values, by overweighting the historical dates according to proximity of the element-magnitudes or their variations with the specified stress values.
